(19) United States
(12) Patent Application Publication
(10) Pub. No.: US 2009/0279322 A1
(43) Pub. Date: Nov. 12, 2009

(54) LIGHT GUIDE UNIT AND BACKLIGHT ASSEMBLY HAVING THE SAME

(75) Inventors: Dong-Hoon KIM, Suwon-si (KR); Joong-Hyun KIM, Suwon-si (KR); Jin-Sung CHOI, Cheonan-si (KR); Hyoung-Joo KIM, Uiwang-si (KR); Kang-Woo LEE, Suwon-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si, Gyeonggi-do (KR)

(21) Appl. No.: 12/407,940

(22) Filed: Mar. 20, 2009

(30) Foreign Application Priority Data
May 9, 2008 (KR) 2008-43322

(51) Int. Cl. G02B 5/02; F21V 8/00

(52) U.S. Cl. 362/558; 362/559

(57) ABSTRACT

A light guide unit includes a body part and a plurality of tunnel lens portions disposed thereon. The tunnel lens portions protrude from an upper surface of the body part in a first direction normal to the upper surface. The tunnel lens portions include an outer surface connected to the upper surface and an inner surface connected to a lower surface of the body part. The outer surface has a concave shape, and respective edges of the concave shape define a first peak and a second peak on the outer surface. The inner surface protrudes in the first direction from the lower surface to define a lamp receiving space. The inner surface has a movement-preventing protrusion which contacts a lamp disposed in the lamp receiving space to prevent the lamp from moving.

This application claims priority to Korean Patent Application No. 2008-43322, filed on May 9, 2008, and all the benefits accruing therefrom under 35 U.S.C. § 119, the contents of which in its entirety are herein incorporated by reference.

### BACKGROUND OF THE INVENTION

1. Field of the Invention

The present invention relates to a light guide unit and a backlight assembly having the light guide unit. More particularly, the present invention relates to a light guide unit disposed between a light source and an optical member in a direct-type backlight assembly, and a backlight assembly having the light guide unit.

2. Description of the Related Art

Generally, a flat display device, such as a liquid crystal display (“LCD”) device, for example, includes a light source apparatus which provides a display panel of the LCD device with light to display an image thereon. The light source apparatus is typically disposed below the display panel.

In general, the light source apparatus is classified as either an edge type backlight assembly or a direct-type backlight assembly, based on a position of a light source in the light source apparatus. In an edge type backlight assembly, the light source may be a cold cathode fluorescent lamp (“CCFL”), for example, disposed near one or more edges of the backlight assembly. In the direct-type backlight assembly, however, a plurality of lamps is disposed below the display panel. As a result, a large amount of light, in comparison to the edge type backlight assembly, is provided to the display panel. Thus, the direct-type backlight assembly is typically employed in large-sized display devices, instead of the edge type backlight assembly.

In any flat display device, however, an important technical issue is reducing and/or minimizing a thickness of the display device, to reduce an overall size of the display device. Thus, decreasing the thickness of the backlight assembly is also important. However, a luminance uniformity of the backlight assembly must be maintained, and an interval between a light source and an optical member, such as a diffusion plate, should be greater than a predetermined interval to obtain sufficient luminance uniformity.

Thus, it is desired to decrease the interval distance between the light source and the optical member without lowering luminance uniformity and/or luminance. For example, a technology has been developed which enhances a light diffusion function and a light condensing function of an optical member. In another example, a technology has been developed which achieves a complex function into one optical member.

However, in the abovementioned technologies, there are limits to reducing the thickness of the display devices utilizing those technologies. Thus, a new structure, having a substantially decreased thickness of a direct-type backlight assembly, is required.

### BRIEF SUMMARY OF THE INVENTION

Exemplary embodiments of the present invention provide a light guide unit adjacent to a light source, the light source having a substantially enhanced luminance uniformity.

Exemplary embodiments of the present invention also provide a backlight assembly having the light guide unit.

According to an exemplary embodiment of the present invention, a light guide unit includes a body part and a plurality of tunnel lens portions. The body part includes an upper surface and a lower surface opposite the upper surface. Tunnel lens portions of the plurality of tunnel lens portions are disposed on the body part. More specifically, the lens portions protrude from the upper surface of the body part in a first direction normal to the upper surface of the body part. A longitudinal axis of the lens portions extends in a second direction substantially perpendicular to the first direction. The lens portions are spaced apart from each other by predetermined distances measured along a third direction substantially perpendicular to the first direction and the second direction. The tunnel lens portions include an outer surface and an inner surface. The outer surface is connected to the lower surface of the body part and having a concave shape, edges of the concave shape defining a first peak and a second peak on the outer surface. The inner surface is connected to the lower surface of the body part and protruding in the first direction from the lower surface to define a lamp receiving space thereunder. The inner surface has a movement-preventing protrusion which contacts a lamp to prevent the lamp from moving.

In an exemplary embodiment of the present invention, a cross-section of each of the tunnel lens portions, taken in the third direction, includes a first ellipse defined by the outer surface of the tunnel lens portion and having a longitudinal axis aligned in the third direction and a latitudinal axis aligned in the first direction. The cross-section of each of the tunnel lens portions (taken in the third direction) further includes a second ellipse defined by the inner surface of the tunnel lens portion and having a longitudinal axis aligned in the first direction and a latitudinal axis aligned in the third direction.

In an exemplary embodiment of the present invention, a radius of curvature of the concave shape may be in a range from approximately 2.3 mm to approximately 2.7 mm. A radius of curvature of an edge portion between the inner surface and the lower surface may be in a range from approximately 0.23 mm to approximately 0.27 mm.

In an exemplary embodiment of the present invention, a light-scattering pattern may be disposed at an edge portion between the inner surface and the lower surface to decrease light leakage therebetween. A light-diffusion pattern may be disposed on the upper surface of the body part at the concave shape to diffuse incident light thereon. A luminance-increasing pattern may be disposed on the upper surface between adjacent tunnel lens portions to increase an emission of light therethrough.

In an exemplary embodiment of the present invention, the light guide unit may further include an optical member supporting part protruding from the upper surface of the body part between adjacent tunnel lens portions to support an optical member thereon. Alternatively, a plurality of holes may be disposed in the upper surface of the body member between adjacent tunnel lens portions, and the optical member supporting member may be inserted into each hole of the plurality of holes.

According to an alternative exemplary embodiment of the present invention, a backlight assembly includes a receiving container, a plurality of lamps, a lamp supporter and a light guide unit. The receiving container includes a bottom plate and a sidewall extending in a first direction from the bottom plate. Each lamp of the plurality of lamps includes a lamp tube and an electrode part disposed at an end portion of the lamp tube, wherein a longitudinal axis of each of the lamps is aligned in a second direction substantially perpendicular to the first direction. The lamp supporter includes a fixing part attached to the bottom plate and a lamp supporting part extending from the fixing part in the first direction to contact each of the lamp tubes. The light guide unit includes a body part and a plurality of tunnel lens portions. The body part includes an upper surface and a lower surface opposite the upper surface. Tunnel lens portions of the plurality of tunnel lens portions are disposed on the body part. More specifically, the lens portions protrude from the upper surface of the body part in the first direction normal to the upper surface of the body part. A longitudinal axis of the lens portions extends in a second direction substantially perpendicular to the first direction. The lens portions are spaced apart from each other by predetermined distances measured along a third direction substantially perpendicular to the first direction and the second direction. The tunnel lens portions include an outer surface and an inner surface. The outer surface is connected to the lower surface of the body part and having a concave shape, edges of the concave shape defining a first peak and a second peak on the outer surface. The inner surface is connected to the lower surface of the body part and protruding in the first direction from the lower surface to define a lamp receiving space thereunder. The inner surface has a movement-preventing protrusion which contacts a lamp to prevent the lamp from moving.

In an exemplary embodiment of the present invention, a cross-section of each of the tunnel lens portions, taken in the third direction, comprises: a first ellipse defined by the outer surface of the tunnel lens portion and having a longitudinal axis aligned in the third direction and a latitudinal axis aligned in the first direction; and a second ellipse defined by the inner surface of the tunnel lens portion and having a longitudinal axis aligned in the first direction and a latitudinal axis aligned in the third direction.

In an exemplary embodiment of the present invention, a light-diffusion pattern may be disposed on the outer surface at the concave shape to diffuse light incident thereon, and a luminance-increasing pattern disposed on the upper surface between adjacent tunnel lens portions to increase an emission of light therethrough. A light-scattering pattern may be formed at an edge portion between the internal surface and the lower surface to decrease light leakage therebetween.

In an exemplary embodiment of the present invention, the backlight assembly may further include an optical member disposed on the light guide unit. The lamp supporter may further include an optical member supporting part protruding in the first direction from the upper surface of body part between adjacent tunnel lens portions to support the optical member thereon, and a hole disposed in the upper surface of the body member between adjacent tunnel lens portions, wherein the optical member supporting part is inserted into the hole.

The light guide unit further comprises an optical member supporting part protruding from the upper surface between adjacent tunnel lens portions to support the optical member thereon.

The light guide unit further comprises an optical member supporting part protruding from outer surface at the concave shape to support the optical member thereon.

In an exemplary embodiment of the present invention, the backlight assembly may further include a lamp holder connected to the end portion of each of the lamp tubes to supply a driving voltage to the electrode part, and a side frame covering the lamp holder and supporting a peripheral edge of the optical member.

The lamp supporting part surrounds at least an end portion of each of the lamp tubes to support each of the lamp tubes.

The backlight assembly according to an exemplary embodiment of the present invention may further include lamp fixing rings connected to each of the lamp supporting part and the inner surface, and each of the lamp tubes may be inserted into each of the lamp fixing rings.

The backlight assembly according to an exemplary embodiment of the present invention may further include a plurality of the light guide units.

The backlight assembly according to an exemplary embodiment of the present invention may further include a reflective sheet disposed between the bottom plate of the receiving container and the lower surface of the body part.

According to a light guide unit and a backlight assembly having the light guide unit according to exemplary embodiments of the present invention, in a direct-type backlight assembly used in a flat display device, a luminance and a luminance uniformity of light exiting the backlight assembly is substantially improved. Moreover, an interval distance between a light source and an optical member, e.g., an optical distance, is substantially decreased. Therefore, the light guide unit and the backlight assembly having the light guide unit according to exemplary embodiments of the present invention provide a display device having a substantially decreased thickness.

### BRIEF DESCRIPTION OF THE DRAWINGS

The above and other aspects, features and advantages of the present invention will become more readily apparent by describing in further detail exemplary embodiments thereof with reference to the accompanying drawings, in which:

FIG. 1 is an exploded perspective view of a backlight assembly according to an exemplary embodiment of the present invention;

FIG. 2 is a perspective view of a light guide unit of the backlight assembly according to the exemplary embodiment of the present invention shown in FIG. 1;

FIG. 3 is a partial cross-sectional view taken along line III-III′ of FIG. 2;

FIG. 4 is a partial cross-sectional view of a light guide unit of the backlight assembly according to the exemplary embodiment of the present invention shown in FIG. 3;

FIG. 5 is a partial cross-sectional view taken along line V-V′ of FIG. 1;

FIG. 6 is a partial cross-sectional view taken along line VI-VI′ of FIG. 1;

FIGS. 7A and 8A are graphs of curvature radius versus luminance uniformity of light exiting a backlight assembly according an exemplary embodiment of the present invention;

FIGS. 7B and 8B are graphs of curvature radius versus luminance of light exiting from a backlight assembly according to an exemplary embodiment of the present invention;

FIG. 9 is a graph of distance between lamps versus luminance of light for each of an exemplary embodiment of the present invention wherein a concave surface is not formed in an external surface of a tunnel lens portion and an alternative exemplary embodiment of the present invention wherein a concave surface is formed in an external surface of a tunnel lens portion;

FIG. 10 is a partial cross-sectional view of a backlight assembly according to an alternative exemplary embodiment of the present invention;

FIG. 11 is a partial cross-sectional view of a backlight assembly according to another alternative exemplary embodiment of the present invention;

FIG. 12 is a partial cross-sectional view of a backlight assembly according to yet another alternative exemplary embodiment of the present invention; and

FIG. 13 is an exploded perspective view of a backlight assembly according to still another alternative exemplary embodiment of the present invention.

### DETAILED DESCRIPTION OF THE INVENTION

The invention will now be described more fully hereinafter with reference to the accompanying drawings, in which exemplary embodiments of the invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements and/or components, but do not preclude the presence or addition of one or more other features, regions, integers, steps, operations, elements, components and/or groups thereof.

Furthermore, relative terms, such as “lower” or “bottom” and “upper” or “top” may be used herein to describe one element's relationship to other elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on the “upper” side of the other elements. The exemplary term “lower” can, therefore, encompass both an orientation of “lower” and “upper,” depending upon the particular orientation of the figure. Similarly, if the device in one of the figures were turned over, elements described as “below” or “beneath” other elements would then be oriented “above” the other elements. The exemplary terms “below” or “beneath” can, therefore, encompass both an orientation of above and below. Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning which is consistent with their meaning in the context of the relevant art and the present disclosure, and will not be interpreted in an idealized or overly formal sense unless expressly so defined herein.

Exemplary embodiments of the present invention are described herein with reference to cross section illustrations which are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes which result, for example, from manufacturing. For example, a region illustrated or described as flat may, typically, have rough and/or nonlinear features. Moreover, sharp angles which are illustrated may be rounded. Thus, the regions illustrated in the figures are schematic in nature and their shapes are not intended to illustrate the precise shape of a region and are not intended to limit the scope of the present invention.

Hereinafter, exemplary embodiments of the present invention will be described in further detail with reference to the accompanying drawings.

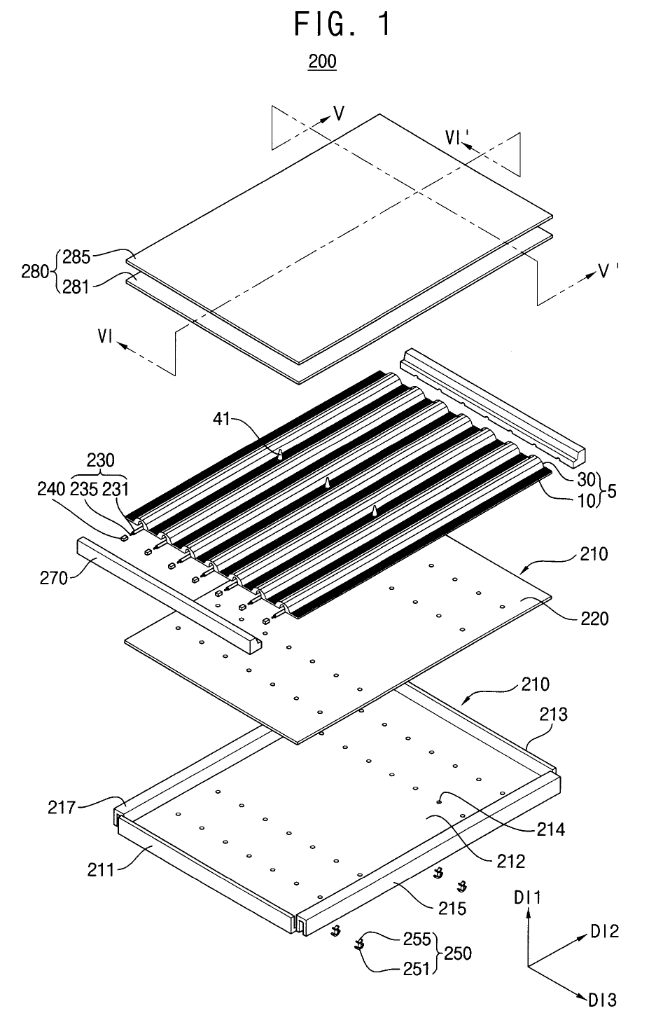

FIG. 1 is an exploded perspective view of a backlight assembly according to an exemplary embodiment of the present invention.

The backlight assembly 200 according to an exemplary embodiment of the present invention provides a flat display device such as a liquid crystal display (“LCD”) device, for example, with a backlight which provides light to the LCD device to display an image thereon. In an exemplary embodiment, the backlight assembly 200 is disposed below the LCD device to directly supply the light to the LCD device.

Referring to FIG. 1, the backlight assembly 200 includes a light guide unit 5, a receiving container 210, a plurality of lamps 230 and a lamp supporter 250.

The light guide unit 5 according to an exemplary embodiment diffuses light 7 (FIG. 5) emitted from lamps 230 of the plurality of lamps 230 such that a luminance distribution of the light 7 which exits the backlight assembly 200 is uniform. In an exemplary embodiment, the light guide unit 5 includes a polymer resin having excellent light transmittance, light diffusion ratio, thermal resistance, chemical resistance and physical strength, for example. Specifically, the polymer resin includes, for example, polymethylmethacrylate, polyamide, polyimide, polypropylene or polyurethane, but alternative exemplary embodiments are not limited thereto.

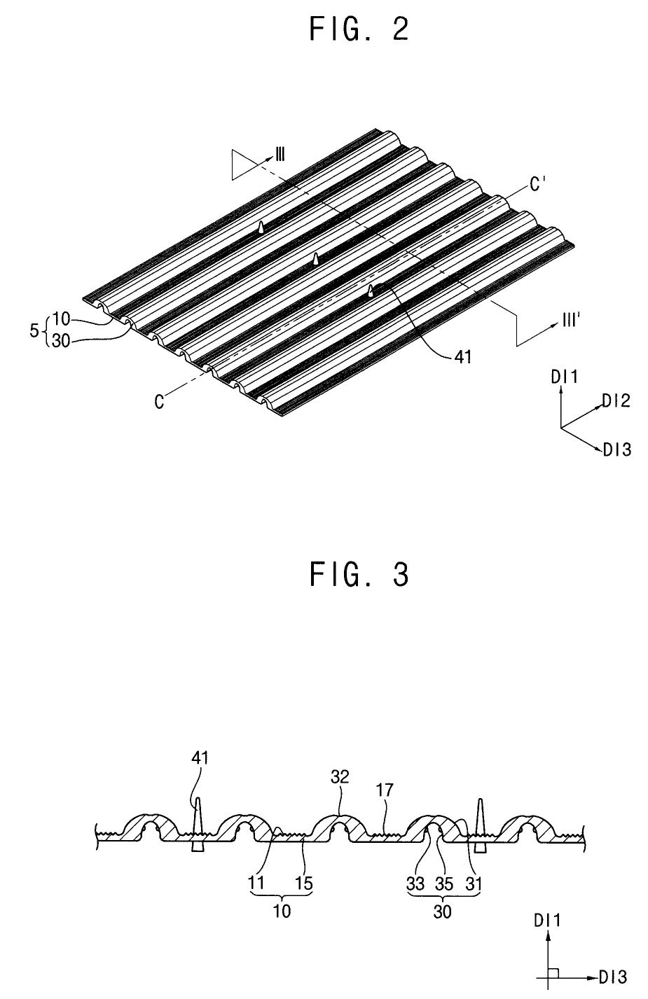

FIG. 2 is a perspective view of a light guide unit of the backlight assembly according to the exemplary embodiment of the present invention shown in FIG. 1. FIG. 3 is a partial cross-sectional view taken along line III-III′ of FIG. 2.

Referring to FIGS. 1, 2 and 3, the light guide unit 5 includes a body portion 10 and a plurality of tunnel lens portions 30.

The body portion 10 may have a substantially rectangular shape. The body portion 10 according to an exemplary embodiment includes an upper surface 11 and a lower surface 15 disposed opposite to, e.g., facing, the upper surface 11. In an exemplary embodiment, the body portion 10 may have the thickness of approximately 2 mm.

A direction substantially perpendicular to a plane defining the upper surface 11, e.g., a line normal to the upper surface 11 will herein be referred to as a first direction DI1. Further, a direction in which a long, e.g., longitudinal, side of the body portion 10 is aligned will be referred to as a second direction DI2, while a direction in which a short, e.g., latitudinal, side of the body portion 10 is aligned will be referred to as a third direction DI3. Thus, the first direction DI1, the second direction DI2 and the third direction DI3 are mutually perpendicular to one another, e.g., are mutually orthogonal. Thus, in terms of the first direction DI1, the second direction DI2 and the third direction DI3, FIG. 2 shows a cross-section of the light guide unit 5 taken along a line substantially perpendicular to the second direction DI2.

Tunnels lens portions 30 of the plurality of tunnel lens portions 30 extend in the second direction DI2, and a cross-sectional view taken along a line substantially perpendicular to the second direction DI2 has a substantially tunnel shape, as shown in FIG. 2. The tunnel lens portions 30 are formed at the body portion 10 and spaced apart from each other by a predetermined distance measured in the third direction DI3. Each of the tunnel lens portions 30 includes an external surface 31 and an internal surface 35.

The external surface 31 is protruded from the upper surface 11 toward the first direction DI1. The external surface 31 has a symmetrical shape with respect to a central line C-C′ in parallel with the second direction DI2.

A concave surface 32 is formed at the external surface 31 along the central line C-C′. Specifically, the concave surface 32 is disposed at the external surface 31 to curve inward toward the lower surface 15 along the central line C-C′.

A radius of curvature of the concave surface 32 affects luminance and luminance uniformity of the light 7 (FIG. 5) which exits the light guide unit 5. The radius of curvature of the concave surface 32 will be described in further detail below.

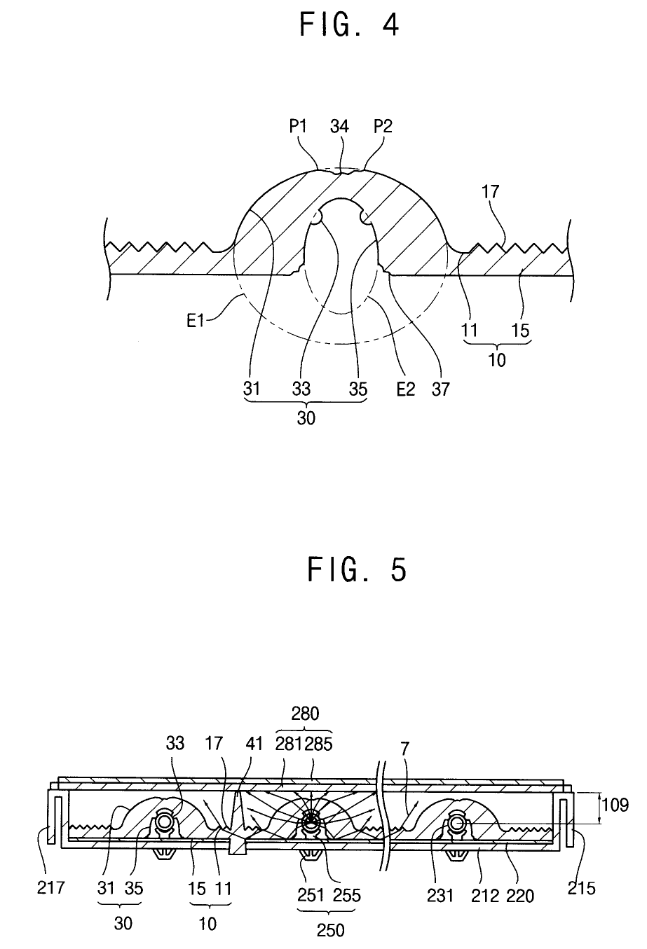

FIG. 4 is a partial cross-sectional view of a light guide unit of the backlight assembly according to the exemplary embodiment of the present invention shown in FIG. 3.

Referring to FIG. 4, when viewed as a cross-section of the tunnel lens portion 30 taken along the line substantially perpendicular to the second direction DI2, it can be seen that, due to a shape of the concave surface 32, the external surface 31 includes two peaks, e.g., a first peak P1 and a second peak P2, formed at respective sides, e.g., peripheral edges, of the concave surface 32.

Accordingly, a structure in which the first peak P1 and the second peak P2 are disposed at the respective sides of the concave surface 32 will hereinafter be referred to as a double peak structure.

When the tunnel lens portion 30 according to an exemplary embodiment has the double peak structure, an amount of the light 7 which exits in the first direction DI1 through the concave surface 32 may be substantially decreased when a lamp 230 (FIG. 1) is disposed in a lamp receiving space defined by the internal surface 35. Thus, the light 7 which exits from the lamp 230 is effectively diffused in an exemplary embodiment of the present invention.

In an exemplary embodiment, a light-diffusion pattern 34 which diffuses incident light may include, for example, a random dot pattern formed by a prism patterning process or, alternatively, by a sandblasting process, for example. More specifically, the light-diffusion pattern 34 may be formed in the concave surface 32, as shown in FIG. 4. The light-diffusion pattern 34 diffuses the light 7 which is emitted in the first direction DI1. Therefore, a bright line generated at an upper portion of the tunnel lens portion 30 is effectively prevented.

To enhance the luminance uniformity of the light 7 which exits from the light guide unit 5, a luminance enhancing pattern 17 may be formed at the upper surface 11 between adjacent tunnel lens portions 30, as shown in FIGS. 3 and 4. In an exemplary embodiment, the luminance enhancing pattern 17 may include, for example, a random dot pattern formed by a prism patterning process or, alternatively, by a sandblasting process, for example.

When viewed as a cross-section of the tunnel lens portion 30, as shown in FIG. 4, the external surface 31 according to an exemplary embodiment may have a profile of a critical curve. Specifically, the external surface 31 from the upper surface 11 to the first peak P1 and the second peak P2 may have a profile substantially corresponding to half of a first ellipse E1 taken along a longitudinal axis thereof. More specifically, the longitudinal axis of the first ellipse E1 may be substantially parallel to the third direction DI3, and a latitudinal axis of the first ellipse E1 may be substantially parallel to the first direction DI1. In an alternative exemplary embodiment, a cross-sectional profile of the external surface 31 may have a substantially semicircle shape (not shown).

The internal surface 35 is concave, e.g., curves inward, from the lower surface 15 toward the external surface 31, and extended substantially in the second direction DI2. Thus, the internal surface 35 form a lamp receiving space which extended substantially in the second direction DI2.

When viewed as a cross-section of the tunnel lens portion 30, as shown in FIG. 4, the internal surface 35 may also have a profile of a critical curve. Specifically, the internal surface 35 may have a profile corresponding to half of a second ellipse E2 taken along a latitudinal axis thereof. A center of the second ellipse E2 corresponds to a center of the first ellipse E1, and a longitudinal axis and the latitudinal axis of the second ellipse E2 may be substantially parallel to the first direction DI1 and the third direction DI3, respectively. Thus, in an exemplary embodiment, the latitudinal axis of the first ellipse E1 may be longer than the longitudinal axis of the second ellipse E2, as best shown in FIG. 4.

Still referring to FIG. 4, a plurality of movement-preventing protrusions 33 is formed at the internal surface 35. Movement-preventing protrusions 33 of the plurality of movement-preventing protrusions 33 are formed on the internal surface 35 in an integrally formed structure, e.g., the movement-preventing protrusions 33 are extensions of the internal surface 35. The movement-preventing protrusions 33 are coupled to the lamp 230, and thereby effectively prevent the lamp 230 from moving away from the internal surface 35. In an exemplary embodiment, the movement-preventing protrusions 33 may be disposed in a substantially symmetric shape with respect to the central line C-C′. Alternatively, the movement-preventing protrusions 33 may be disposed in a substantially zigzag shape at the internal surface 35 interposed along, e.g., substantially following, the central line C-C′.

An edge portion 37 where the internal surface 35 meets the lower surface 15 protrudes further from the internal surface 35 than a peripheral portion thereof, and the light 7 thereby leaks through the edge portion 37. An amount of the light 7 which leaks through the edge portion 37 is affected by a radius of curvature of the edge portion 37. The radius of curvature of the edge portion 37 for substantially decreasing the light leakage and for maintaining a substantially uniform luminance of the light 7 will be described in further detail below.

In an exemplary embodiment, a light-scattering pattern (not shown) such as a dot pattern, for example, may be formed by a prism patterning process or a sandblasting process in the edge portion 37 (FIG. 4). When the light-scattering pattern is formed, light leakage is effectively prevented from the edge portion 37.

The light guide unit 5 according to an exemplary embodiment may further include an optical member supporting part 41. The optical member supporting part 41 protrudes from the upper surface 11 between adjacent tunnel lens portions 30. In an exemplary embodiment, the optical member supporting part 41 has a height of substantially 7.5 mm, which is greater than a height of the tunnel lens portion 30. An upper portion of the optical member supporting part 41 may have a sharp shape or, alternatively, a rounded shape to effectively support an optical member 280 which will be described in greater detail below.

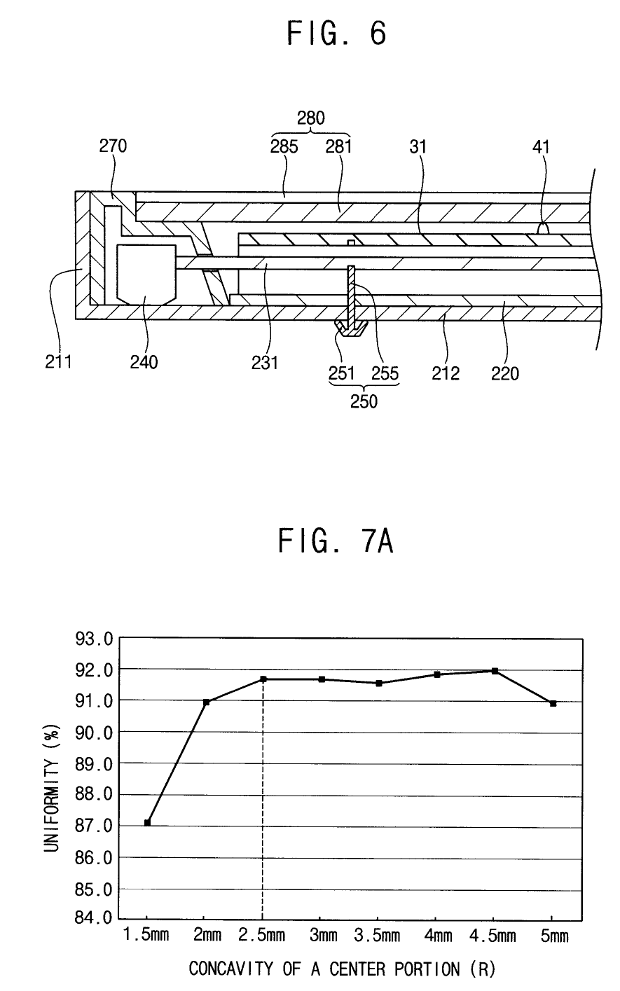

FIG. 5 is a partial cross-sectional view taken along line V-V′ of FIG. 1. FIG. 6 is a partial cross-sectional view taken along line VI-VI′ of FIG. 1.

Referring to FIGS. 1, 5 and 6, the receiving container 210 receives the light guide unit 5. The receiving container 210 according to an exemplary embodiment includes a bottom plate 212, a first sidewall 211, a second sidewall 213, a third sidewall 215 and a fourth sidewall 217.

The bottom plate 212 may have a substantially rectangular shape, e.g., a plate shape, in which a longitudinal side is parallel to, e.g., is aligned with, the second direction DI2, and a latitudinal side in parallel with the third direction DI3. The light guide unit 5 is disposed at the bottom plate 212. The lower surface 15 of the light guide unit 5 is disposed at the bottom plate 212.

The backlight assembly 200 may further include a light reflective sheet 220 disposed between the bottom plate 212 and the lower surface 15 of the light guide unit 5.

The first sidewall 211 and the second sidewall 213 are disposed at opposite latitudinal sides of the bottom plate 212. The third sidewall 215 and the fourth sidewall 217 are disposed at opposite longitudinal sides of the bottom plate 212, respectively. A plurality of locking protrusions which guide the optical members 280 is formed at upper surfaces of the third sidewall 215 and the fourth sidewall 217. Heights of the first to fourth sidewalls 211, 213, 215 and 217, respectively, are higher than a height of the light guide unit 5.

The lamps 230 according to an exemplary embodiment may include a cold cathode fluorescent lamp (“CCFL”) having a substantially cylindrical shape. The lamps 230 may be disposed at the bottom plate 212 substantially parallel to the second direction DI2. The lamps 230 may be spaced apart from each other by a predetermined distance (as measured in the third direction DI3).

Each of the lamps 230 includes a lamp tube 231 and an electrode part 235. The lamp tube 231 is disposed in a lamp receiving space defined by the bottom plate 212 and the internal surface 35 of the light guide unit 5, as shown in FIG. 6. An end portion of the lamp tube 231 protrudes toward an outer peripheral portion of the tunnel lens portion 30. The electrode part 235 is formed at opposite longitudinal end portions of the lamp tube 231.

The backlight assembly 200 may further include a lamp holder 240.

The lamp holder 240 is connected to the electrode part 235 which protrudes toward an the outer peripheral portion of the tunnel lens portion 30, as illustrated in FIG. 6, to supply a driving voltage, for example, to the electrode part 235. In an exemplary embodiment, the lamp holder 240 is fixed to the bottom plate 212 to support the lamp 230.

A power providing wire (not shown) may be connected to, e.g., soldered to, the electrode part 235 through a hole formed through the lamp holder 240. Alternatively, the lamp holder 240 may be a socket type lamp holder 240, in which case the lamp holder 240 is detachably connected to the electrode part 235.

A position of the lamp supporter 250 corresponds to a lower side of the lamp tube 231. The lamp supporter 250 is fixed to the bottom plate 212 to support the lamp tube 231. Thus, the lamp supporter 250 includes a fixing portion 251 and a lamp supporting portion 255.

Specifically, an inserting hole 214 corresponding to the position of the lamp supporter 250 is formed through the bottom plate 212 and the light reflective sheet 220. The fixing portion 251 suppresses a rear surface of the bottom plate 212 to be fixed thereto, as shown in FIG. 5.

The lamp supporting portion 255 extends from the fixing portion 251 to pass through the inserting hole 214 to support a lower portion of an outer surface of the lamp tube 231. Two supporting protrusions contact the lamp tube 231 and are thus formed at the lamp supporting portion 255 in a substantially symmetrical shape with respect to the central line C-C′. The supporting protrusions contact two points of the lower outer surface of the lamp tube 231.

A plurality of movement-preventing protrusions 33, which is formed on the internal surface 35 of the tunnel lens portion 30, contacts an upper outer surface of the lamp tube 231 supported by the lamp supporting portion 255. Thus, movement-preventing protrusions 33 of the plurality of movement-preventing protrusions 33 prevent the lamp 230 from moving in the first direction DI1.

The backlight assembly 200 may further include an optical member 280 disposed on the light guide unit 5. The optical member 280 may include a diffusion plate 281 and a diffusion sheet 285 disposed on the diffusion plate 281.

The diffusion plate 281 may be formed from a polymer resin similar to the light guide unit 5, as described in greater detail above. The diffusion plate 281 and the diffusion sheet 285 diffuse the light 7 (FIG. 5) which exits the light guide unit 5 to thereby substantially enhance a luminance uniformity of the guide unit 5 according to an exemplary embodiment of the present invention.

When an interval distance between the lamp 230 and the diffusion plate 281 is less than a predetermined value, it becomes impossible to prevent a bright line from being generated. Thus, the interval distance between the lamp 230 and the diffusion plate 281 in an exemplary embodiment is greater than the predetermined value. In an exemplary embodiment, the predetermined value is an optical distance 109. To decrease a thickness of the backlight assembly 200, however, the optical distance 109 is small, e.g., is minimized in an exemplary embodiment of the present invention.

Specifically, the backlight assembly 200 according to an exemplary embodiment includes the light guide unit 5 which has a special shape special function, and the optical distance 109 of the backlight assembly 200 is substantially smaller than a corresponding optical distance 109 of a backlight assembly of the prior art.

In an exemplary embodiment, for example, the optical distance 109 may be approximately a few millimeters.

In an exemplary embodiment, for example, the diffusion plate 281 is supported by the optical member supporting part 41 of the light guide unit 5. Further, a height of the optical member supporting part 41 may be approximately 7.5 mm, as described in greater detail above. In addition, respective heights of the first peak P1 and the second peak P2 of the tunnel lens portion 30 may be approximately 7.0 mm. Additionally, the interval distance between the diffusion plate 281 and a minimum point of the concave surface 32 of the tunnel lens portion 30 may be approximately 2.5 mm.

Moreover, as shown in FIG. 5, the lamp 230 is disposed between a center of the second ellipse E2 and the concave surface 32, but is not disposed at a center of the second ellipse E2. Specifically, as shown in FIG. 5, the lamp 230 is disposed at a position closer to the internal surface 35 of the tunnel lens portion 30 than to the bottom plate 212. Thus, an interval distance between the lamp 230 and the diffusion plate 281, e.g., the optical distance 109, may be in a range from approximately 3 mm to approximately 3.5 mm.

The backlight assembly 200 according to an exemplary embodiment may further include a side frame 270. The side frame 270 covers the lamp holder 240 and supports a first peripheral edge portion of the diffusion plate 281.

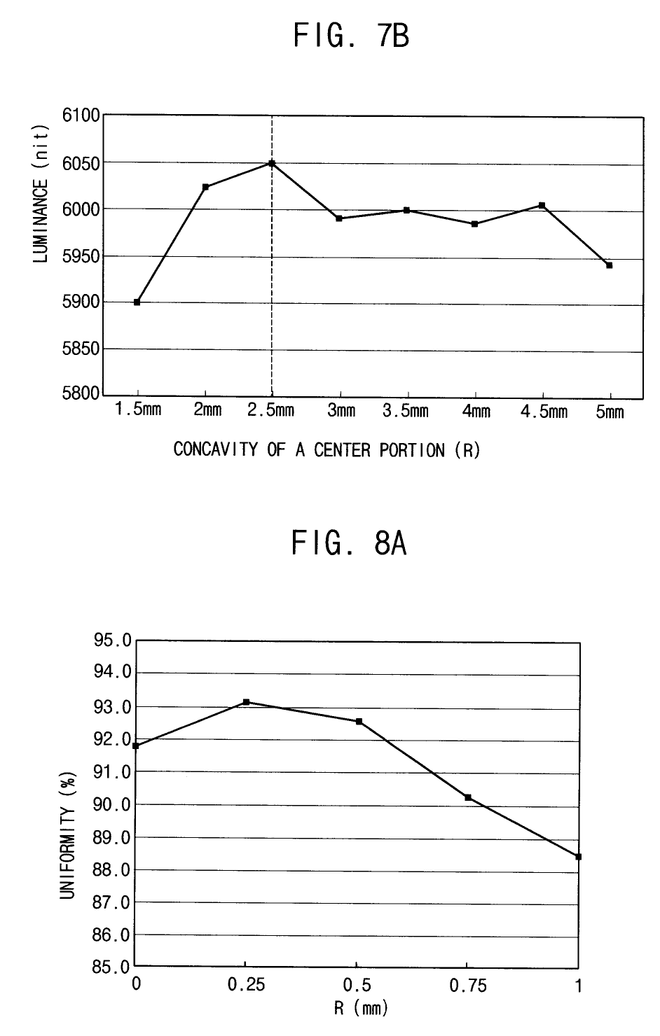

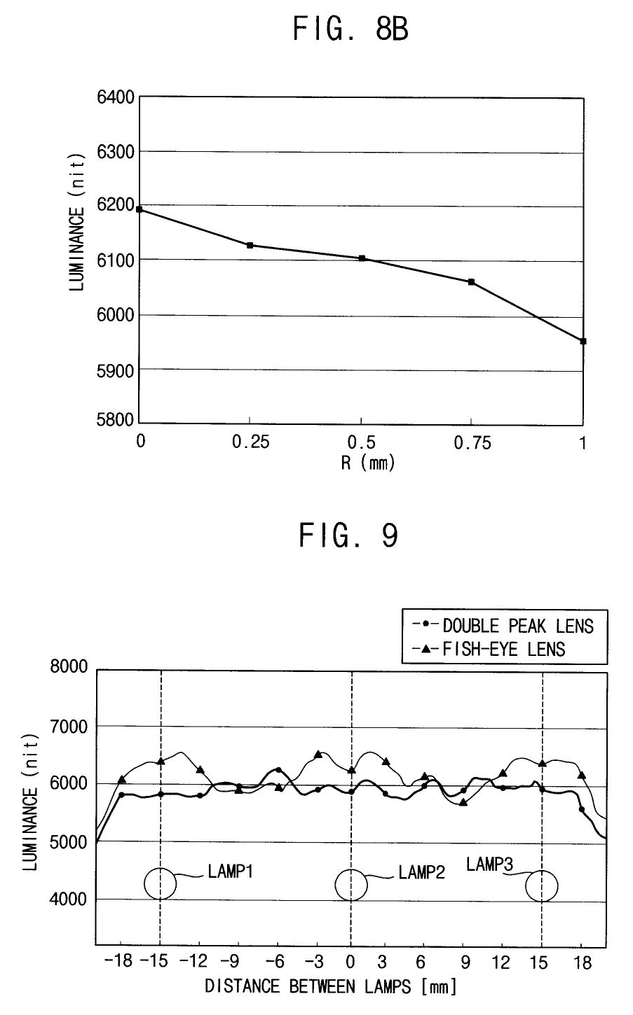

FIGS. 7A and 8A are graphs of curvature radius versus luminance uniformity of light exiting from a backlight assembly according to an exemplary embodiment of the present invention. FIGS. 7B and 8B are graphs of curvature radius versus luminance of light exiting from a backlight assembly according to an exemplary embodiment of the present invention. More specifically, FIGS. 7A and 7B relate to a curvature radius of a concave surface of the tunnel lens portion 30 (FIG. 4), while FIGS. 8A and 8B relate to a curvature of radius of the edge portion 37 between the internal surface 35 of the tunnel lens portion 30 and the lower surface 15 of the body portion 10 thereof (FIG. 4).

Referring to FIG. 7A, when a radius of curvature of the concave surface 32 is approximately 1.5 mm, a corresponding luminance uniformity is approximately 87 percent. When the radius of curvature is increased, the luminance uniformity is increased. However, when the radius of curvature is in a range of approximately 2.5 mm to approximately 4.5 mm, the luminance uniformity is essentially constant at a luminance uniformity of approximately 92 percent.

Referring to FIG. 7B, when the radius of curvature is approximately 2.5 mm, a luminance of the exiting light is effectively maximized at approximately 6050 nits.

Thus, to maximize the luminance as well as the luminance uniformity, the radius of curvature of the concave surface 32 according to an exemplary embodiment is in a range from approximately 2.3 mm to approximately 2.7 mm.

Referring to FIG. 8A, when a radius of curvature of the edge portion 37 is approximately 0.25 mm, luminance uniformity is effectively maximized at approximately 93 percent. However, referring to FIG. 8B, when the radius of curvature of the edge portion 37 is increased, it luminance of the light is decreases. When the radius of curvature is approximately 0.25 mm, a corresponding decrease in the luminance is effectively minimized, and thus, the radius of curvature of the edge portion 37 according to an exemplary embodiment may be in a range from approximately 0.23 mm to approximately 0.27 mm.

FIG. 9 is a graph of distance between lamps versus luminance of light for each of an exemplary embodiment of the present invention wherein a concave surface is not formed in an external surface of a tunnel lens portion and an alternative exemplary embodiment of the present invention wherein a concave surface is formed in an external surface of the tunnel lens portion 30 thereof. In FIG. 9, a vertical axis represents luminance of light exiting the lens portion 30, and a horizontal axis represents a distance between lamps, e.g., between a first lamp lamp1, a second lamp lamp2 and a third lamp lamp3.

Referring to FIG. 9, in a case of a fish-eye lens in which a top portion of the external surface 31 protrudes (e.g., by removing the concave surface 32 from the external surface 31 of the tunnel lens portion 30), an average luminance of light from the fish-eye lens is approximately 6,196 nits, and a luminance uniformity of the exiting light from the fish-eye lens is approximately 86% (not shown). In a case of a double peak lens such as the tunnel lens portion 30 according to an exemplary embodiment of the present invention, an average luminance of exiting light from the double peak lens is approximately 5,958 nits and a luminance uniformity of the exiting light from the double peak lens is approximately 91.8% (not shown).

Thus, it a luminance decrease of the double peak lens as compared to the fish-eye lens is less than approximately 4% when compared to the fish-eye lens; however, a luminance uniformity increase of the double peak compared to the fish-eye lens is approximately 7%. Therefore, a light diffusing function of the double peak lens according to an exemplary embodiment of the present invention is substantially increased.

Thus, in the light guide unit 5 and the backlight assembly 200 having the light guide unit 5 according to an exemplary embodiment of the present invention, the optical distance 109 is substantially decreased due to a structure of the light guide unit 5, and the thickness of the backlight assembly 200 is thereby substantially decreased.

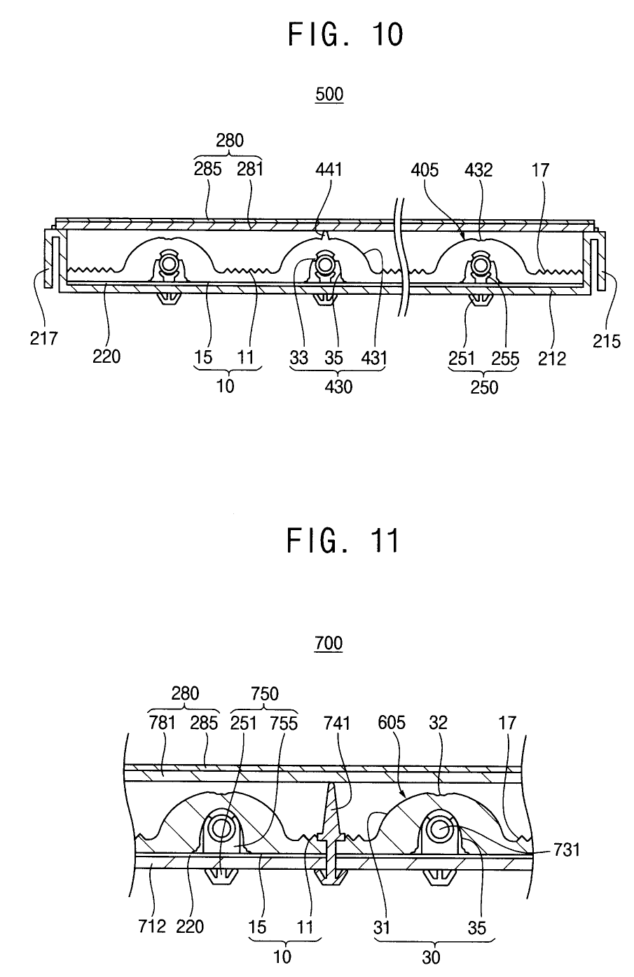

FIG. 10 is a partial cross-sectional view of a backlight assembly 500 according to an alternative exemplary embodiment of the present invention.

Referring to FIG. 10, the backlight assembly 500 according to an exemplary embodiment is substantially the same as the backlight assembly 200 of FIGS. 1 to 9 except for a shape of a light guide unit 405. Thus, the same reference numerals are used in FIG. 10 to refer to the same or like components as those shown in FIGS. 1 to 9, and thus, any repetitive detailed description thereof will hereinafter be omitted.

In addition, the light guide unit 405 according to an exemplary embodiment is substantially the same as the light guide unit 5 of FIGS. 1 to 9 except that an optical member supporting part 441 is formed in a protrusion shape at a concave surface 432 of an external surface 431 of a tunnel lens portion 430, and is not formed between adjacent tunnel lens portions 430. Thus, any repetitive detailed description thereof will hereinafter be omitted, as well.

In the light guide unit 405 according to an exemplary embodiment, the optical member supporting part 441 is formed on the concave surface 432 of the tunnel lens portion 430, and the optical member supporting part 441 is thereby shorter than the optical member supporting part 41 of the exemplary embodiment described in greater detail above with reference to FIGS. 1-9. Thus, damage, e.g., breakage, of the optical member supporting part 441 is further prevented, and the optical member supporting part 441 is more easily, e.g., efficiently, manufactured.

FIG. 11 is a partial cross-sectional view of a backlight assembly 700 according to another alternative exemplary embodiment of the present invention.

Referring to FIG. 11, the backlight assembly 700 according to an exemplary embodiment is substantially the same as the backlight assembly 200 of FIGS. 1 to 9 except that shapes of a light guide unit 605 and a lamp supporter 750 are changed, and the backlight assembly 700 further includes an optical member supporting member 741. Thus, the same reference numerals are used in FIG. 10 to refer to the same or like components as those shown in FIGS. 1 to 9, and thus, any repetitive detailed description thereof will hereinafter be omitted.

Likewise, the light guide unit 605 according to an exemplary embodiment is substantially the same as the light guide unit 5 of FIGS. 1 to 9 except that the movement-preventing protrusion 33 (FIG. 3) and the optical member supporting part 41 (FIG. 3) are removed and, instead, a through hole is formed at a position from which the optical member supporting part 41 is removed, as shown in FIG. 11. Thus, the same reference numerals are used in FIG. 11 to refer to the same or like components as those shown in FIGS. 1 to 9, and thus, any repetitive detailed description thereof will hereinafter be omitted, as well.

Referring to FIG. 11, the optical member supporting member 741 is inserted into the through hole by passing the optical member supporting member 741 through a hole formed through a bottom plate 712 of the receiving container 210 (FIG. 1). Thus, the optical member supporting member 741 supports a diffusion plate 781.

In an exemplary embodiment, the lamp supporter 750 is substantially the same as the lamp supporter 250 of FIGS. 1 to 6 except that a lamp supporting part 755 of the lamp supporter 750 extends from a lower outer surface of the lamp tube 731 to a portion of an upper outer surface thereof, and a lamp supporting part 755 surrounds the lamp tube 731 to prevent the lamp tube 731 from moving. Thus, any repetitive detailed description thereof will hereinafter be omitted.

Still referring to FIG. 11, the through hole into which the optical member supporting member 741 is inserted is formed through the light guide unit 605, thereby effectively preventing damage, e.g., breakage, of the light guide unit 605. Moreover, the lamp supporting part 755 of the lamp supporter 750 extends toward an upper outer surface of the lamp tube 731, so that the movement-preventing protrusion 33 (FIG. 4) may be omitted from the internal surface of the light guide unit 605. Thus, damage, e.g., breakage of a lamp 230 (FIG. 1) due to the movement-preventing protrusion 33 is effectively prevented.

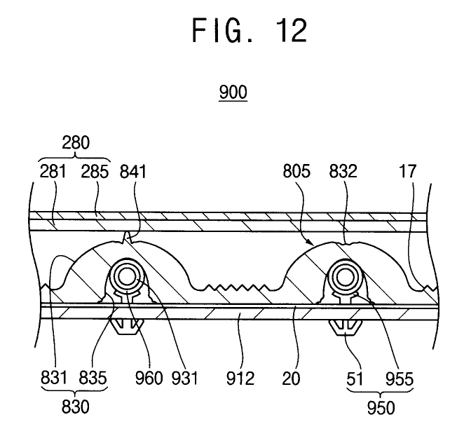

FIG. 12 is a partial cross-sectional view of a backlight assembly 900 according to yet another alternative exemplary embodiment of the present invention.

Referring to FIG. 12, the backlight assembly 900 according to an exemplary embodiment is substantially the same as the backlight assembly 200 of FIGS. 1 to 9 except for a shape of a light guide unit 805, and the backlight assembly 900 further includes a lamp fixing ring 960. Thus, the same reference numerals are used in FIG. 12 to refer to the same or like components as those shown in FIGS. 1 to 9, and thus, any repetitive detailed description thereof will hereinafter be omitted.

In addition, the light guide unit 805 according to an exemplary embodiment is substantially the same as the light guide unit 5 of FIGS. 1 to 9 except that an optical member supporting part 841 is formed in a protrusion shape at a concave surface 832 of an external surface 831 of a tunnel lens portion 830 and is not formed between adjacent tunnel lens portions 830, and the movement-preventing protrusion 33 (FIG. 5) is removed from an internal surface 835, as shown in FIG. 12. Thus, any repetitive detailed description thereof will hereinafter be omitted, as well.

The lamp fixing ring 960 according to an exemplary embodiment may include an elastic material, such as rubber, for example. Thus, when a lamp tube 931 is inserted into the lamp fixing ring 960, the lamp tube 931 thereafter contacts a lamp supporting part 955 of a lamp supporter 950 and the internal surface 835. Thus, the lamp tube 931 is fixed to a bottom plate 912 of the receiving container 210 (FIG. 1).

Thus, in the light guide unit 805 according to an exemplary embodiment, breakage of the optical member supporting part 841 (due to a comparatively short length of the optical member supporting part 841) is effectively prevented. Moreover, the movement-preventing protrusion 33 (FIG. 5) may be omitted from the internal surface 835 of the tunnel lens portion 830, and a manufacturing efficiency of the light guide unit 805 is thereby effectively improved. Furthermore, the lamp fixing ring 960 performs a buffer function, and the lamp tube 931 is thereby further protected from damage from an external impact, for example.

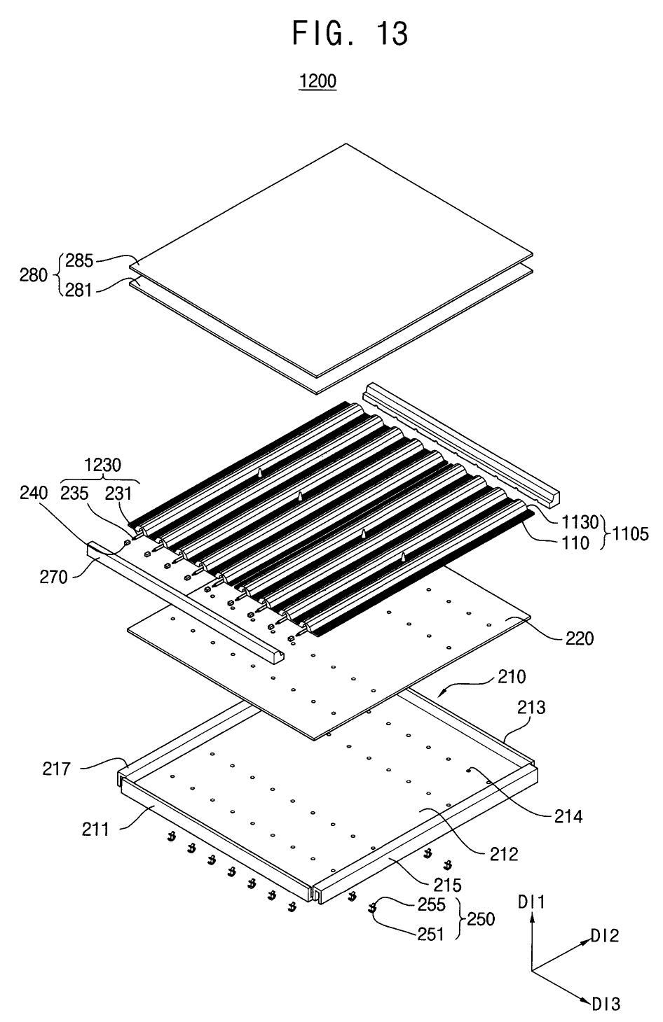

FIG. 13 is an exploded perspective view of a backlight assembly according to still another alternative exemplary embodiment of the present invention.

Referring to FIG. 13, the backlight assembly 1200 according to the present embodiment is substantially the same as the backlight assembly 200 of FIGS. 1 to 9 except that a light guide unit 1105 is divided into a plurality thereof, e.g., the backlight assembly 1200 according to an exemplary embodiment of the present invention includes a plurality of light guide units 1105. Specifically, the light guide unit 1105 according to an exemplary embodiment is divided into two rows, as shown in FIG. 13. It will be noted that the same reference numerals are used in FIG. 13 to refer to the same or like components as those shown in FIGS. 1 to 9, and thus, any repetitive detailed description thereof will hereinafter be omitted.

Light guide units 1105 of the plurality of light guide units 1105 according to an exemplary embodiment may be substantially the same as the light guide unit 5 of FIGS. 1 to 9.

In an exemplary embodiment, two light guide units 1105 are arranged next to each other and aligned in a substantially longitudinal direction of tunnel lens portions 1130, e.g., the third direction DI3 substantially perpendicular to the second direction DI2. Thus, according to an exemplary embodiment, a number of lamps 1230 which may be disposed in the light guide unit 1105 is effectively increased.

Thus, the light guide unit and the backlight assembly having the light guide unit in accordance with exemplary embodiments of the present invention as described herein, in a direct-type backlight assembly used in a flat display device, a luminance and a luminance uniformity of light which exits the light guide unit is substantially increased and/or effectively improved. Moreover, an interval distance between a light source and an optical member, e.g., an optical distance, is substantially decreased. Therefore, the light guide unit and the backlight assembly having the light guide unit according to exemplary embodiments of the present invention result in a substantial decrease in a thickness of a display device employing the same.

The present invention should not be construed as being limited to the exemplary embodiments set forth herein. Rather, these exemplary embodiments are provided so that this disclosure will be thorough and complete and will fully convey the concept of the present invention to those skilled in the art.

While the present invention has been particularly shown and described with reference to exemplary embodiments thereof, it will be understood by those of ordinary skill in the art that various changes in form and details may be made therein without departing from the spirit or scope of the present invention as defined by the following claims.

What is claimed is:

1. A light guide unit comprising:
a body part comprising an upper surface and a lower surface opposite the upper surface; and
a plurality of tunnel lens portions disposed on the body part, wherein
the tunnel lens portions protrude from the upper surface of the body part in a first direction normal to the upper surface of the body part,
a longitudinal axis of the tunnel lens portions extends in a second direction substantially perpendicular to the first direction,
the tunnel lens portions are spaced apart from each other by predetermined distances measured along a third direction substantially perpendicular to the first direction and the second direction,
the tunnel lens portions comprise:
an outer surface connected to the lower surface of the body part to have a concave shape, edges of the concave shape defining a first peak and a second peak on the outer surface; and
an inner surface connected to the lower surface of the body part to protrude in the first direction from the lower surface to define a lamp receiving space thereunder, the inner surface comprising a movement-preventing protrusion which contacts a lamp disposed in the lamp receiving space to prevent the lamp from moving.

2. The light guide unit of claim 1, wherein a cross-section of each of the tunnel lens portions, taken in the third direction, comprises:
a first ellipse defined by the outer surface of the tunnel lens portion and having a longitudinal axis aligned in the third direction and a latitudinal axis aligned in the first direction; and
a second ellipse defined by the inner surface of the tunnel lens portion and having a longitudinal axis aligned in the first direction and a latitudinal axis aligned in the third direction.

3. The light guide unit of claim 2, wherein a radius of curvature of the concave shape is in a range from approximately 2.3 mm to approximately 2.7 mm.

4. The light guide unit of claim 2, wherein a radius of curvature of an edge portion between the inner surface and the lower surface is in a range from approximately 0.23 mm to approximately 0.27 mm.

5. The light guide unit of claim 1, further comprising a light-scattering pattern disposed at an edge portion between the inner surface and the lower surface to decrease light leakage therebetween.

6. The light guide unit of claim 1, further comprising a light-diffusion pattern disposed on the outer surface at the concave shape to diffuse light incident thereon.

7. The light guide unit of claim 1, further comprising a luminance-increasing pattern disposed on the upper surface of the body part between adjacent tunnel lens portions to increase an emission of light therethrough.

8. The light guide unit of claim 1, further comprising an optical member supporting part protruding in the first direction from the upper surface of the body part between adjacent tunnel lens portions to support an optical member thereon.

9. The light guide unit of claim 1, further comprising a plurality of holes disposed in the upper surface of the body member between adjacent tunnel lens portions, wherein an optical member supporting member is inserted into each hole of the plurality of holes.

10. A backlight assembly comprising:
a receiving container comprising a bottom plate and a sidewall extending from the bottom plate in a first direction;
a plurality of lamps disposed on the bottom plate, each lamp of the plurality of lamps comprising a lamp tube and an electrode part disposed at an end portion of the lamp tube, wherein a longitudinal axis of each of the lamps is aligned in a second direction substantially perpendicular to the first direction;
a lamp supporter comprising a fixing part attached to the bottom plate and a lamp supporting part extending from the fixing part in the first direction to contact each of the lamp tubes; and
a light guide unit comprising:
a body part comprising an upper surface and a lower surface opposite the upper surface; and
a plurality of tunnel lens portions disposed on the body part, wherein
the tunnel lens portions protrude from the upper surface of the body part in the first direction normal to the upper surface of the body part,
a longitudinal axis of the tunnel lens portions extends in a second direction substantially perpendicular to the first direction,
the tunnel lens portions are spaced apart from each other by predetermined distances measured along a third direction substantially perpendicular to the first direction and the second direction,
the tunnel lens portions comprise:
an outer surface connected to the lower surface of the body part to have a concave shape, edges of the concave shape defining a first peak and a second peak on the outer surface; and
an inner surface connected to the lower surface of the body part to protrude in the first direction from the lower surface to define a lamp receiving space thereunder, the inner surface comprising a movement-preventing protrusion which contacts a lamp disposed in the lamp receiving space to prevent the lamp from moving.

11. The backlight assembly of claim 10, wherein a cross-section of each of the tunnel lens portions, taken in the third direction, comprises:
a first ellipse defined by the outer surface of the tunnel lens portion and having a longitudinal axis aligned in the third direction and a latitudinal axis aligned in the first direction; and
a second ellipse defined by the inner surface of the tunnel lens portion and having a longitudinal axis aligned in the first direction and a latitudinal axis aligned in the third direction.

12. The backlight assembly of claim 10, further comprising:
a light-diffusion pattern is disposed on the outer surface at the concave shape to diffuse light incident thereon, and
a luminance-increasing pattern disposed on the upper surface between adjacent tunnel lens portions to increase an emission of light therethrough,
wherein a light-scattering pattern is disposed at an edge portion between the internal surface and the lower surface to decrease light leakage therebetween.

13. The backlight assembly of claim 10, further comprising an optical member disposed on the light guide unit.

14. The backlight assembly of claim 13, wherein the lamp supporter further comprises:
an optical member supporting part protruding in the first direction from the upper surface of body part between adjacent tunnel lens portions to support the optical member thereon; and
a hole disposed in the upper surface of the body member between adjacent tunnel lens portions, wherein the optical member supporting part is inserted into the hole.

15. The backlight assembly of claim 13, wherein the light guide unit further comprises an optical member supporting part protruding from the upper surface between adjacent tunnel lens portions to support the optical member thereon.

16. The backlight assembly of claim 13, wherein the light guide unit further comprises an optical member supporting part protruding from outer surface at the concave shape to support the optical member thereon.

17. The backlight assembly of claim 13, further comprising:
a lamp holder connected to the end portion of each of the lamp tubes to supply a driving voltage to the electrode part; and
a side frame covering the lamp holder and supporting a peripheral edge of the optical member.

18. The backlight assembly of claim 10, wherein the lamp supporting part surrounds at least an end portion of each of the lamp tubes to support each of the lamp tubes.

19. The backlight assembly of claim 10, further comprising lamp fixing rings connected to each of the lamp supporting part and the inner surface, wherein each of the lamp tubes is inserted into each of the lamp fixing rings.

20. The backlight assembly of claim 10, further comprising a plurality of the light guide units.
